(19) United States
(12) Patent Application Publication
(10) Pub. No.: US 2025/0111012 A1
(43) Pub. Date: Apr. 3, 2025

(54) Variance Analysis in an Observability Platform

(71) Applicant: Hound Technology, Inc., San Francisco, CA (US)

(72) Inventors: Danyel Fisher, San Francisco, CA (US); Max Edmands, San Francisco, CA (US); Sarah Jeanne Voegeli, Golden, CO (US)

(21) Appl. No.: 18/545,924

(22) Filed: Dec. 19, 2023

Related U.S. Application Data
(60) Provisional application No. 63/587,090, filed on Sep. 30, 2023.

(51) Int. Cl. G06F 17/18; G06F 16/95

(52) U.S. Cl. CPC G06F 17/18; G06F 16/95

(57) ABSTRACT

A system and method for analyzing large data sets to determine variances is described. In an example implementation, the system may include an observability platform configured to receive a user request to perform a variance analysis in association with a user-selected dataset on an observability platform. Data representing the user-selected dataset may be retrieved based on the request and may include many dimensions of data on the observability platform. Baseline and outlier representative samples may be generated based on the user-selected dataset. A server may be configured to include a variance analysis engine to perform the request for variance analysis. The observability platform may generate a plurality of data visualizations based on a result data set of the variance analysis. The data visualizations may be ranked using one or more disparity data metrics and may be provided for display in an order based on the ranking on the observability platform.

### BACKGROUND

The present disclosure relates to systems and methods for analyzing large data sets to determine variances. In particular, the present disclosure relates to systems and methods for variance analysis in an observability platform.

In recent years, tracking and optimizing performance of Internet-enabled software applications has generated larger and larger data sets. In particular, various application performance monitoring (APM) solutions have emerged to enable organizations to improve user experiences by tracking key software application performance metrics using monitoring software and telemetry data. With the abundance of data available, and with increasing complexity and structures, it is often difficult to identify the root causes that may affect the user experience of a software application, such as latency. Specifically, as software applications are updated to fix bugs, release new features, and/or deploy applications on more complex structures, such as distributed systems or cloud computing platforms, the user experience may be negatively affected for reasons that are harder to determine. As such, there is a persistent need to improve the tools used to investigate and analyze the large amounts of data used to observe the performance of software applications. It would be beneficial to enable users of application performance monitoring solutions to better analyze outliers to identify the root causes.

### SUMMARY

The present disclosure relates to an observability platform that enables performance monitoring data to be analyzed using comparative data analysis to identify variances in attributes of the dataset across one or more dimensions. An observability platform relies on user-supplied and/or user-managed data stores that are accessed through the Internet. An observability platform may be configured to receive a user request to perform a variance analysis in association with a user-selected dataset on an observability platform. Data representing the user-selected dataset may be retrieved based on the request and may include many dimensions of data on the observability platform. An outlier representative sample may be generated based on the user-selected dataset. A baseline representative sample may be generated based on data representing the user-selected dataset. A server may be configured to include a variance analysis engine to perform the request for variance analysis. The observability platform may generate a plurality of data visualizations based on a result data set of the variance analysis. The data visualizations may be ranked using one or more disparity data metrics and may be provided for display in an order based on the ranking on the observability platform.

Other implementations of one or more of these aspects and other aspects include corresponding systems, apparatus, and computer programs, configured to perform the various action and/or store various data described in association with these aspects. Numerous additional features may be included in these and various other implementations, as discussed throughout this disclosure.

The features and advantages described herein are not all-inclusive and many additional features and advantages will be apparent in view of the figures and description. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a high-level block diagram for variance analysis illustrating a system including an observability platform in accordance with some implementations.

FIG. 2 is a block diagram illustrating a computing device including software modules used in the system of FIG. 1, including the observability platform in accordance with some implementations.

FIG. 3 is a block diagram illustrating a variance analysis engine of the observability platform in accordance with some implementations.

FIG. 4 is a block diagram illustrating a database of the observability platform in accordance with some implementations.

FIG. 5 is an example flowchart diagram illustrating a method of generating a variance analysis associated with a user-selected dataset in accordance with some implementations.

FIG. 6 is an example flowchart diagram illustrating a method of generating a variance analysis associated with a user-selected dataset using a heuristic rules engine in accordance with some implementations.

FIG. 7 is an example flowchart diagram illustrating a method of generating a set of data visualizations based on a variance analysis associated with a user-selected dataset in accordance with some implementations.

FIG. 8 is an example flowchart diagram illustrating a method of modifying a query based on one or more disparity metrics associated with one or more attributes based on a variance analysis associated with a user-selected dataset in accordance with some implementations.

FIG. 9 is an example flowchart diagram illustrating a method of modifying a query to include a filter based on user input associated with one or more disparity metrics associated with one or more attributes of a trace dataset based on a variance analysis associated with a user-selected dataset in accordance with some implementations.

FIG. 10 is an example screenshot illustrating an example variance analysis user interface of the observability platform in accordance with an implementation.

FIG. 11 is an example screenshot illustrating an example data visualization user interface of the observability platform in accordance with an implementation.

FIG. 12 is an example screenshot illustrating an example line graph data visualization user interface of the observability platform in accordance with an implementation.

FIGS. 13A-D are example screenshots illustrating an example data visualization user interface of the observability platform in accordance with an implementation.

### DETAILED DESCRIPTION

As set forth in detail below, the technology described herein provides an innovative approach to visualizing data in large data sets. In particular, the systems and methods described below advantageously enable a user to generate data visualizations that explore variance data metrics in an observability platform. Part of this process includes embedding a user interface that receives user input that identifies the type of problem or issue that the user intends to investigate. The user interface enables a user to select variant data that differs in some way from baseline data and a process to generate a set of variance data metrics, based on the user input, that includes various information specific to the dataset that was imported into the observability platform, such as a description of names in a database schema that a user may query, a list of domain knowledge metadata such as special column names and what they mean, baseline data values in comparison to the user's input, and a listing of variance data analysis on applicable dimensions of data. After generating the variance analysis data metrics, the dimensions may be ranked based on statistical analysis indicating the most highly variant data. In this way, the user is presented with data that may be useful in identifying a root cause for the variance. For example, the response after a variance analysis function is selected, based on a set of data selected by a user, may be a set of histograms for each dimension of data in which there's an identified variance, where the variant data is highlighted in one color, such as yellow, and baseline data is presented in a different color, such as blue. The baseline data may be retrieved from other data within the observability platform, for example. As another example, the response to the variance analysis function being performed may include graphical user interface that includes a set of blocks that indicate a timeline representation of trace data as different functions are executed. In this example, the graphical user interface may quickly identify one or more functions that are taking longer to complete for various parameters being passed, such as a “promo code” in an e-commerce application. Various processes and algorithms are used to determine one or more variance data metrics. In some implementations, a threshold quality level may be incorporated to identify a variance data metric. In an implementation, the response from a variance data analysis function may be incorporated into a filter such that the query is modified to enable the user to further investigate the root causes of the variance.

While the present disclosure will now be described below with regard to databases and/or data stores of performance data metrics of production systems connected, through a network, to an observability platform and the user interfaces used to select outlier data objects for variance analysis on the observability platform, it should be understood that the databases and/or data stores described are just one example type of data that may be used with the present disclosure. The present disclosure is applicable to various other types of data including but not limited to relational databases, structured data, unstructured data, NoSQL databases, JSON databases, and so forth.

With reference to the figures, reference numbers may be used to refer to components found in any of the figures, regardless whether those reference numbers are shown in the figure being described. Further, where a reference number includes a letter referring to one of multiple similar components (e.g., user 106a, . . . and 106n), the reference number may be used without the letter to refer to one or all of the similar components.

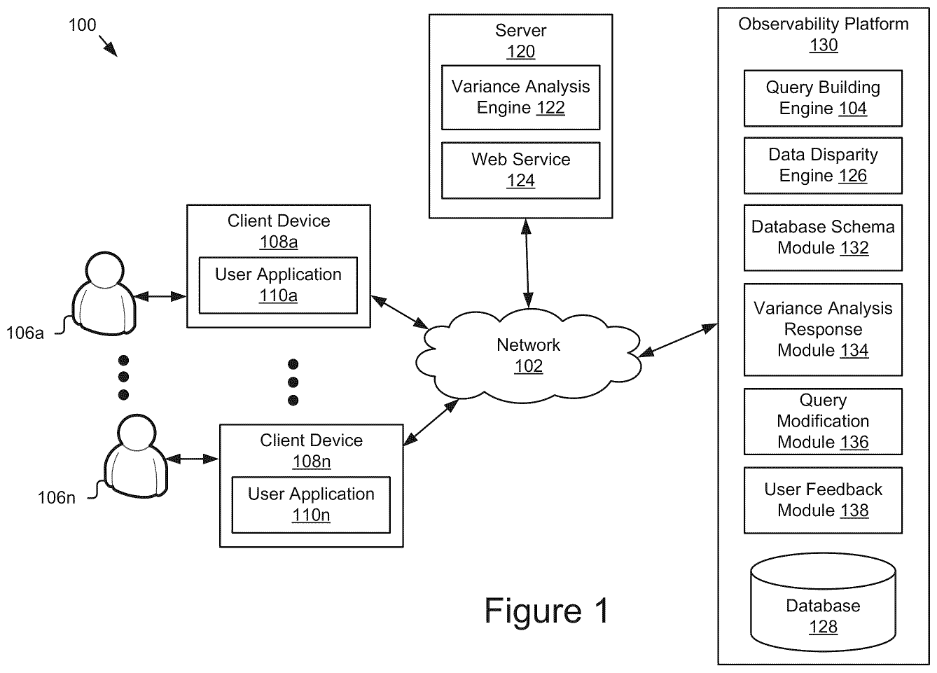

FIG. 1 is a high-level block diagram illustrating an example system 100 for variance analysis in an observability platform using generative artificial intelligence.

The illustrated system 100 may include client devices 108a . . . 108n (also referred to herein individually and/or collectively as 108) that can be accessed by users 106a . . . 106n, a server 120, and an observability platform 130, which are electronically communicatively coupled via a network 102 for interaction and electronic communication with one another, although other system configurations are possible including other devices, systems, and networks. For example, the system 100 could include any number of client devices 108, servers 120, observability platforms 130, networks 102, and other systems and devices. In some implementations, the observability platform 130 may be located remotely (e.g., separately off the network or physical location) from one or both of the client devices 108 and the server 120.

The network 102 may be a conventional type, wired or wireless, and may have numerous different configurations including a star configuration, token ring configuration, or other configurations. Furthermore, the network 102 may include any number of networks and/or network types. For example, the network 102 may include, but is not limited to, one or more local area networks (LANs), wide area networks (WANs) (e.g., the Internet), virtual private networks (VPNs), mobile (cellular) networks, wireless wide area network (WWANs), WiMAX® networks, personal area networks (PANs) (e.g., Bluetooth® communication networks), peer-to-peer networks, near field networks (e.g., NFC, etc.), and/or other interconnected data paths across which multiple devices may communicate, various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The client devices 108a . . . 108n (also referred to individually and collectively as 108) may be computing devices having data processing and communication capabilities. In some implementations, a client device 108 may include a memory, a processor (e.g., virtual, physical, etc.), a power source, a network interface, software and/or hardware components, such as a display, graphics processing unit (GPU), wireless transceivers, keyboard, camera (e.g., webcam), sensors, firmware, operating systems, web browsers, applications, drivers, and various physical connection interfaces (e.g., USB, HDMI, etc.). The client devices 108a . . . 108n may couple to and communicate with one another and the other entities of the system 100 via the network 102 using a wireless and/or wired connection, such as the local hub or the application server. Examples of client devices 108 may include, but are not limited to, mobile phones, tablets, laptops, desktops, netbooks, server appliances, servers, virtual machines, smart TVs, media streaming devices, or any other electronic device capable of accessing a network 102. The system 100 may include any number of client devices 108, including client devices 108 of the same or different type. A plurality of client devices 108a . . . 108n are depicted in FIG. 1 to indicate that the server 120 and observability platform 130 may interact with multiplicity of users 106a . . . 106n on a multiplicity of client devices 108a . . . 108n.

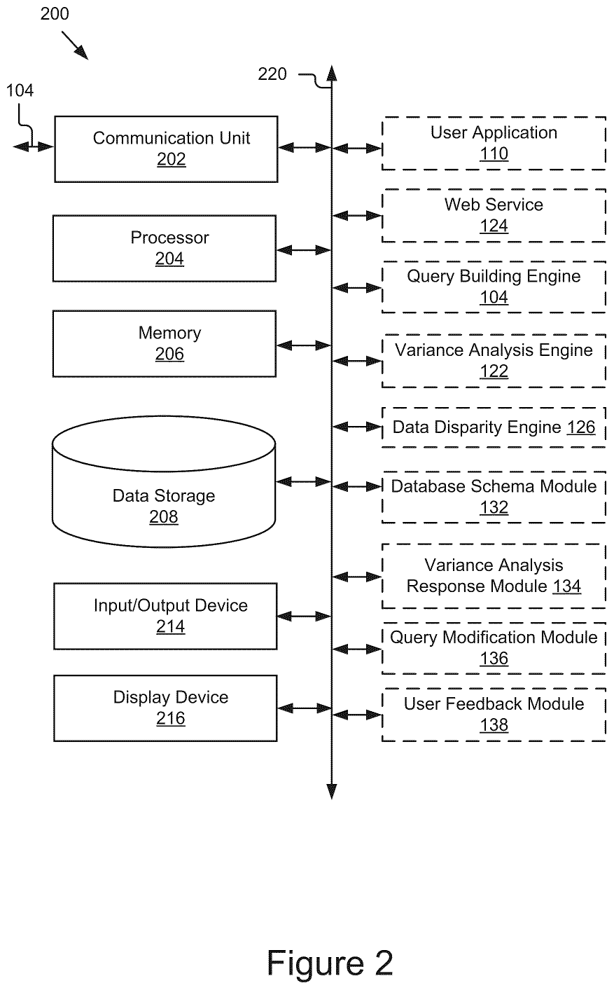

The client devices 108 may also store and/or operate other software such as a user application 110 (e.g., an instance of a user application 110a . . . 110n), an operating system, other applications, etc., that are configured to interact with the server 120 and/or the observability platform 130 via the network 102. In some implementations, the client device 108 may run a user application 110. For example, the user application 110 may be one or more of web, mobile, enterprise, and cloud application. The user application 110 may communicate with the server 120 and the observability platform 130. For example, the user application 110 may include a browser that may run JavaScript or other code to access the functionality provided by other entities of the system 100 coupled to the network 102. The user application 110 may connect to the server 120 via the web service 124, send one or more user selections of data, receive response data from the server 120, send the response data to the observability platform 130, and display the results on the client device 108. In some implementations, the client devices 108 may be implemented as a computing device 200 as will be described below with reference to FIG. 2.

In the example of FIG. 1, the entities of the system 100, such as the server 120 and the observability platform 130 may be, or may be implemented by, a computing device including a processor, a memory, applications, a database, and network communication capabilities similar to that described below with reference to FIG. 2. In some implementations, each one of the entities 120 and 130 of the system 100 may be a hardware server, a software server, or a combination of software and hardware.

The server 120 may include data processing, storing, and communication capabilities, as discussed elsewhere herein. For example, the server 120 may include one or more hardware servers, server arrays, storage devices, centralized and/or distributed/cloud-based systems, etc. In some implementations, the server 120 may include one or more virtual servers, which operate in a host server environment and access the physical hardware of the host server including, for example, a processor, a memory, applications, a database, storage, network interfaces, etc., via an abstraction layer (e.g., a virtual machine manager). In some implementations, the server 120 may be a Hypertext Transfer Protocol (HTTP) server, a Representational State Transfer (REST) service, or other server type, having structure and/or functionality for processing and satisfying content requests and/or receiving content from the other entities coupled to the network 102. The server 120 may implement one or more stateful services and store session state for one or more client devices 108 interacting with it. For example, the server 120 may keep track of one or more requests from client devices 108, which client device has opened which file, current read and write pointers for files, which files are locked by which client device 108, etc.

In some implementations, the server 120 may be remote to the client device 108 and/or the observability platform 130, such that the server 120 communicates with the observability platform 130 to perform functions, thereby reducing complexity of the server 120. In the example of FIG. 1, the server 120 may include a web service 124 and a variance analysis engine 122. The web service 124 may be dedicated to providing access to various services and information resources hosted by the server 120 via web, mobile, enterprise, and/or cloud applications. The web service 124 may include one or more of a software as a service, infrastructure as a service, platform as a service, function as a service, etc. For example, the web service 124 may include on-demand cloud computing service and associated application programming interface (API) for providing distributed computing processing capacity and software tools. In another example, the web service 124 may include allowing users to rent a virtual cluster of machines for deploying applications. It should be noted that the list of services provided as examples for the web service 124 above are not exhaustive and that others are contemplated in the techniques described herein.

In an implementation, the variance analysis engine 122 may comprise a third-party analytical data engine, accessible through an API. In such an implementation, the server 120 comprises a third-party server, wherein the web service 124 comprises the API through which the third-party analytical data engine is accessed. In another implementation, the variance analysis engine 122 may comprise an analytical data engine incorporated into the system of the observability platform. As such, the variance analysis engine 122 may be closely integrated into the existing operations of the observability platform. In other implementations, the variance analysis engine 122 may comprise a specialized analytical data engine tuned for a specific type of use case, such as performance monitoring of software applications used in production. In other implementations, the variance analysis engine 122 operates primarily on client devices 108, embedded within the user application 110.

The observability platform 130 may include data processing, storing, and communication capabilities, as discussed in a related application, U.S. application Ser. No. 17/837,924, titled “Impatient System for Querying Stateless Computing Platforms,” and filed on Jun. 10, 2022, hereby incorporated by reference. The observability platform 130 may be implemented as a serverless computing architecture that allocates machine resources on demand to perform one or more computational tasks. The observability platform 130 may rely on the server 120 to maintain session state. In the example of FIG. 1, the observability platform 130 may include a query building engine 104 that uses an impatient query engine and lambda function(s) (not pictured). A lambda function may be a self-contained serverless application code written in a supported language and runtime to perform one or more computational tasks. For example, a function may be an independent unit of execution and deployment, such as a microservice. The observability platform 130 is configured to execute many instances of the same function or of different functions in an efficient and flexible manner. The observability platform 130 executes each function in its own container. For example, when a function is created, the observability platform 130 packages it into a new container and executes that container on a multi-tenant cluster of machines on demand. In some implementations, the observability platform 130 executes one or more functions in response to events (e.g., multiple individual requests with associated timestamps) and automatically manages the computing resources required by that code. For example, the observability platform 130 may be configured to receive HTTP requests from the server 120 via an API of the web service 124, automatically provision back-end services triggered by the HTTP requests and deallocate such services when corresponding application code is not in use. The observability platform 130 sends the response generated by the functions for individual requests to the server 120 which then collates the responses into a final result. In some implementations, the observability platform 130 may also include a database 128 to store structured data in a relational database and a file system (e.g., HDFS, NFS, etc.) for unstructured or semi-structured data. In some implementations, the observability platform 130 may include an instance of a data storage that stores various types of data for access and/or retrieval by the impatient query engine. For example, the data store may store response data for a set of requests. Other types of user data are also possible and contemplated. It should be understood that a single observability platform 130 may be representative of a cloud computing service provider and there may be multiple cloud computing service providers coupled to the network 102, each having its own server or a server cluster, applications, application programming interface, etc.

In an implementation, the query building engine 104 may include software and/or logic to provide the functionality for enabling a user of the observability platform to use natural language processing (NLP) to generate an executable query using a generative AI as described above. In some implementations, the query building engine 104 may be implemented using programmable or specialized hardware, such as a field-programmable gate array (FPGA) or an application-specific integrated circuit (ASIC). In some implementations, the query building engine 104 may be implemented using a combination of hardware and software. In some implementations, the query building engine 104 may be stored and executed on various combinations of the client device 108, the server 120, and the observability platform 130, or by any one of the client devices 108, the server 120, or the observability platform 130. As depicted in FIG. 1, the query building engine 104 is shown to indicate that the operations performed by the query building engine 104 as described herein may be performed at the observability platform 130. In other implementations, the query building engine 104 may be a thin-client application with some functionality executed on the server 120 and additional functionality executed on the observability platform 130. While the query building engine 104 is described below as a stand-alone component, in some implementations, the query building engine 104 may be part of other applications in operation on the client device 108, the server 120, and the observability platform 130.

As further illustrated in FIG. 1, the observability platform 130 may include software and/or logic to provide the functionality for generating variance data analysis to enable a process to produce a response to received user input for the observability platform 130 to produce data visualizations based on the identified dimensions where the variant data occurs, according to an implementation. For example, the observability platform 130 may include a data disparity engine 126, a database schema module 132, a variance analysis response module 134, a query modification module 136, and a user feedback module 138.

The data disparity engine 126 may include software and/or logic to provide the functionality for enabling the observability platform 130 to generate a list of dimensions in which data disparities exist between a baseline dataset and an outlier dataset, both selected by the user. The disparity analysis is done based on a representative sample of both datasets. For example, an arbitrary number of random values is selected for each dataset, such as ten thousand values. A first histogram is generated for every dimension of data encountered in the baseline dataset and a second histogram is generated for every dimension of data encountered in the outlier dataset. The data disparity engine 126 then utilizes an algorithm that compares the histogram for that dimension in the baseline dataset with the histogram for that dimension in the outlier dataset and generates a set of disparity metrics for that dimension. In an implementation, the situation where the outlier dataset has only one value for a given dimension of data where the baseline dataset has values for the same dimension that are mostly unique for every data point (e.g., in a case where the dimension is a unique ID such as “request ID”), this “nominal” dimension is ignored and/or discounted by the data disparity engine 126. However, the situation where the outlier dataset has only one value for a given dimension where the baseline dataset has many values but not unique for every data point (e.g., a high-cardinality dimension such as “user ID”) may be an indicator of a root cause of the outlier dataset.

An example use case illustrates how the data disparity engine 126 may be used in conjunction with other data analysis to help the viewing user understand and identify a root cause of the outlier data. Using a regular data analysis engine (not pictured), various data analysis may be performed to enable users 106 to determine whether various thresholds have been crossed to trigger alerts, notifications, and the like. For example, users 106 may rely on the observability platform 130 to gain insights into various performance metrics regarding a software application in production on a third-party server and/or service accessible through network 102. The software application may include any number of software services and be structured according to any number of software designs. For the purposes of illustration only, an example software application may be in an e-commerce use case, such as where the software application is used to sell products and/or services on a website and/or mobile application. The software application may include a checkout software service that applies a discount code, such as the word “YOINK” as well as other discount codes, like “FF20OFF” and “JUICY,” among other words. Predetermined queries may be executed, including one or more various queries that are associated with one or more service level objectives (“SLOs”) which indicate, when result(s) meets a threshold, that the one or more SLOs will be violated. These predetermined queries may be generated by users 106 and/or administrators of the observability platform 130 to increase the speed of data retrieval by optimizing the queries through various preprocessing methods and/or techniques, in an implementation.

The data disparity engine 126 may include various techniques, methods, and algorithms to identify data disparities based on outlier data and baseline data. Continuing the example above, an error budget for an SLO, “Customers can check out” using the software application, may be in danger of being exhausted because the “/cart/checkout endpoint returns 200 within 1.2s, 99% of the time over 2 days.” This information may be delivered by the observability platform 130 as a notification to other communication systems accessible by users 106, such as SLACK. The notification is an example of a “Trigger” which executes an action when a query in the observability platform 130 returns a result that meets one or more criteria for the Trigger.

A viewing user 106 may decide to “BUBBLE UP” a set of user-selected data, thus initiating a variance analysis between the outlier dataset and the baseline dataset. For example, a viewing user 106 may select data from an unsuccessful data set, based on a particular SLO, and compare that with a successful data set based on the SLO. The data disparity engine 126 may include functionality to generate a representative dataset to form a baseline dataset, such as selecting, at random, ten thousand values, that met the SLO requirements during a certain time span. Other arbitrary numbers of values may be chosen to generate the baseline dataset, in other implementations. Additionally, a representative dataset may also be generated based on the outlier dataset, such as retrieving ten thousand values from the observability platform 130. In this way, the first dataset that includes the representative sample of data forming the baseline dataset and the second dataset that includes the representative sample of data forming the outlier dataset can be compared. Each dataset includes a number of columns, or dimensions of data. The data disparity engine 126 may include functionality to generate a disparity metric for each dimension of data using an algorithm that compares the histograms generated for each dimension of data. Based on the identified data disparities, as measured by the disparity metric that is a value that indicates the amount of difference between the two histograms, a ranked list of dimensions can be generated by the data disparity engine 126, in an implementation. The ranked list of dimensions may be ranked by the disparity metric, from most different to least different, in an implementation. As described above, nominal data, such as situations where the outlier dataset only has one value in the representative dataset for the specific dimension that is close to unique in the baseline dataset, may be excluded from the analysis, in an implementation. In other implementations, nominal data may be discounted in other ways using various statistical analysis methods and/or heuristics.

Because of the many types of data analysis that may be available to a viewing user 106, different entry points to the “BUBBLE UP” function, or variance analysis, may also be presented to the viewing user 106. A “trace-aware” approach may enable the viewing user 106 to make comparisons between entire trace trees rather than only between individual events—for example, by highlighting that the slower database queries were made while responding to requests from the administrative tool rather than from the checkout service. Additionally, a variance analysis may be enabled in any results table, such as a home screen table, a query results table, a period report results table, a percentage results table, and so forth. For example, a P95 latency (95^{th} Percentile latency value) may be an entry point for a variance analysis in one-click, such as a “Bubbleup on P95 (latency)” link on a P95 line graph, in an implementation.

Another example situation where a variance analysis may be performed include a time over time comparison. In an implementation, a “before and after” variance analysis may be performed to compare what the data looks like across different “before” and “after” conditions. For example, a software release event may have modified the user's application. A viewing user 106 may wish to investigate which dimensions of data were affected by the software release event by generating a variance analysis on the dataset before the release date and after the release date.

As another example, a viewing user 106 may wish to understand their data without specifying a particular comparison. In such cases, a “BUBBLEUP” variance function may be performed on everything, through a user interface element such as a button or drop down menu. Other ways to generate variance analysis results may include performing a “BUBBLEUP” variance function on a row of data in comparison to a neighboring row of data, all rows of data in a table, or a specific set of data as determined through user input with the user interface. As another example, a “why are there errors” one-click variance analysis function may be performed within a user interface to enable users 106 to quickly understand their data and quickly identify where variances across a high number of dimensional data are found through the data disparity engine 126.

The data disparity engine 126 may further include functionality to generate data visualizations, group data by columns, and report data according to pre-programmed templates that identify and show the one or more data disparities. For example, various histograms may be generated to show user-selected variant data in comparison to baseline data across one or more dimensions of data.

Returning to the example above, a data analysis engine may generate additional graphs to show how much of the error budget remains after the last 1 days (e.g., a line graph plotting the error budget on a y-axis over time on an x-axis and displaying the current error budget of 67.14%). Additionally, derived columns and other data may be produced to offer different vantage points and views of the data. An SLI (“Service Level Indicator”) may be a programmatic block of text that is derived from a column of data. An SLI is one type of programmatic code that can be executed in the observability platform 130. A graph may be shown to a user 106 of the observability platform 130 that shows how often the SLI has succeeded over the preceding 1 days (e.g., a line graph plotting the SLI on a y-axis over time on an x-axis and displaying the current SLI at 99.73%). A variance analysis function may be executed through user interaction with a line graph, such as a right-click selection of a portion of the line graph, that generates a graphical user interface that identifies the data disparities across one or more data dimensions based on the user selection and a baseline dataset using the data disparity engine 126.

The data disparity engine 126 may identify data disparities across a number of data dimensions based on other types of data visualizations, such as a heat map user interface that plots data points that represent some quantity of requests to the software application being monitored. The user 106 may selectively interact with the heat map user interface to investigate and determine what may be causing a slowdown at the endpoint (e.g., the shopping cart checkout endpoint described in the Trigger notification above). The heat map user interface may use shades of colors to indicate quantity of requests, such as darker shades representing more requests. The data points may be graphed such that the higher on the y-axis, the data points indicate a longer duration of time of the request. These data points can further be graphed over time on the x-axis. The resulting heat map user interface shows that darker data points that are higher indicate a larger number of requests that take a longer time to complete. The user 106 may then select those higher, darker data points through the heat map user interface to isolate the data set and execute a variance data analysis function that, when executed, enables the user to further investigate what may be causing the slowdown and/or latency through the generated data disparity metrics across data dimensions. In addition to heatmap data visualizations, other data visualizations may be interacted with where the user may select a portion of the data visualization and a baseline dataset may be created in response to the user-selected dataset, where each dataset is generated using a representative sample as described above.

The observability platform 130 may display various types of data visualizations to enable a viewing user to understand and determine a root cause of an issue. For example, a story of each request at a software application, such as the ecommerce software application example above, may be displayed as a trace, showing the request coming in at a “frontend” service, through “checkout,” “cart,” and “productcatalog” as well as the names of software modules being called within each service. For example, after clicking on a slower dot in the above-mentioned heat map user interface, a specific trace may show the amount of time (e.g., duration) that elapsed to execute a specific request, such as “getDiscounts” in the “checkout” service, showing a horizontal bar graph of the duration 1.676 seconds. Different colors may be used to identify the different services and the duration of the requests, in an implementation. Upon selection of the bar graph of 1.676 seconds, a complete listing of the various commands in SQL statements may be shown (e.g., “SELECT checkout.discounts”) and the amount of time for each command (e.g., 131.1 ms, 202.4 ms, 112.2 ms, 166.3 ms, 112.8 ms, 117.7 ms, and so on). The variance analysis function may be executed on such a “RESULT SET” for the amount of time for each command. Based on the user-selected dataset and a baseline dataset, the data disparity engine 126 may execute a variance data analysis function to identify the one or more data dimensions where data disparities are identified. In this way, the data disparity engine 126 enables a user 106 to investigate what commands in the software application being monitored may be potentially malfunctioning based on taking too long to process using the variance data analysis function on the user-selected portion of the trace dataset.

Additionally, the variance data analysis function may be executed based off a user-selected datapoint, such as the right-clicking on the darker dot, as described above, and executing a “BUBBLE UP” function, which executes the variance data analysis function. Other metadata may be shown related to the request, such as the fields of the request, including “Timestamp,” “app_discount_code,” “app_userid,” “app.yeeted,” and “duration_ms” among other data fields, or data dimensions. The data disparity engine 126 may be set up with any number of fields in the observability platform 130. The user 106 may select on each part of the particularly long request to see a breakdown of what SQL queries are being performed. In this example, the same SQL query may be repeating over and over, indicating that there may be an issue or bug to fix.

The data disparity engine 126 may further parse data according to the fields and database schema described that represents the software application being monitored. For example, a database schema module 132 may include software and/or logic to provide the functionality for managing the database schema related to the software application being monitored. In this example above, a column may include “app.discount_code” and a derived column may include “customer_checkout_sli” to indicate that the SLI exists or doesn't exist. The database schema module 132 may also enable user 106 to selectively choose which data is included in a data set through a graphical user interface. For example, the user 106 may selectively highlight various data points that seem to be outliers (e.g., higher than other data points in a heatmap interface) and then select on a “GROUP BY” field in the user interface to include or exclude various columns in a query. The “GROUP BY” field may be prepopulated with various columns, such as “app.discount_code” and “customer_checkout_sli” and the user 106 may unselect “customer_checkout_sli” as an option. Thus, in just a few clicks in the user interface, different data sets may be examined without writing out a specific query in executable programmatic code.

The query building engine 104 may include a user interface that enables the user to simply input natural language text to simplify the process further. For example, a user may input “slow requests” in a “Query Assistant” text field and then click on a “Get Query” button. A parser may identify the terms “slow” and “requests” in the user input and insert a pre-programmed query, in an implementation. The query building engine 104 may include data processing, storing, and communication capabilities, as discussed in a related application, U.S. Application No. 63/499,691, titled “Query Building using Generative AI,” and filed on May 2, 2023, hereby incorporated by reference. In an implementation, the query building engine 104 may enable a user to simply input natural language text such as “Show me why I have errors” to perform a variance analysis on identified errors, based on SLOs and/or other criteria, as described above with respect to the data disparity engine 126.

A variance analysis response module 134 may include software and/or logic to provide the functionality for generating the variance analysis response from the variance analysis engine 122 when executed as a variance data analysis function in the observability platform 130. As described in the examples above, the variance data analysis function may be executed in any graphical user interface, from a line graph that plots the number of counted instances of a particular data dimension, such as a number of checkouts of the software application in the e-commerce space, as well as other data visualizations described, such as a heatmap interface, a set of horizontal histograms, vertical bar charts, and so forth. The variance analysis response module 134 generates the response to the variance data analysis function as executed on the data within the observability platform 130.

A query modification module 136 may include software and/or logic to provide the functionality for modifying a query based on the variance analysis response from the variance analysis response module 134 in the observability platform 130. For example, the response may identify a set of dimensions of data in which the outlier data has measurable data variance from baseline data. The set of dimensions of data may be incorporated into a filter that may be incorporated into the query such that the query may be modified based on the filter. The query modification module 136 may modify the query to incorporate this filter based on the response from the variance analysis response module 134, in an implementation.

A variance analysis response module 134 may include software and/or logic to provide the functionality for interacting with and managing the response of the variance analysis engine 122. For example, the response to the variance analysis, as provided by the variance analysis engine 122, may be presented to a viewing user through an existing user interface. For example, the variance analysis response may include a series of graphical user interfaces that include one or more data visualizations of the one or more dimensions of data that have been identified as having a variance. The variance analysis response may be presented for the viewing user to interact with and create additional variance analyses, generating new queries that may then executed as a query in the observability platform 130. In an implementation, the variance analysis response module 134 processes the response returned by the variance analysis engine 122 and enables a new query to be formed based on the existing query, as modified by the query modification module 136 based on the user input to define the new query. In another implementation, the variance analysis response module 134 may include any number of dimensions that are included in the variance analysis response, based on the database schema module 132 and the data disparity engine 126. In yet another implementation, the query modification module 136 modifies an existing query based on the user interaction with the variance analysis response, such as the user selecting to generate a filter based on the result data set from the variance analysis response.

At this point, the query is run through the observability platform's regular query engine (such as the impatient query system described above) as if the user had manually entered the query through the user interface of the observability platform 130. This includes displaying the results that match the query that was executed, storing the query into a historical record of executed queries, enabling the query to be acted upon (e.g., named, assigned to a collection of queries (a “Board”) or made as a decision point that causes another action to be performed (a “Trigger”). Furthermore, the query may be further modified by the query modification module 136 and re-run.

A user feedback module 138 may include software and/or logic to provide the functionality for requesting user feedback on the query through a user interface, such as a banner asking the user if the variance analysis results helped answer their natural language prompt. For example, the user may have entered “show me why I have errors” into a natural language query builder to enable a variance analysis on identified errors based on a SLO. The user may respond with “yes,” “no,” or “unsure,” for example. The user feedback responses are tracked and correlated with several other pieces of metadata to enable administrators of the observability platform 130 to better understand what can lead to certain user feedback responses by the user.

Other variations and/or combinations are also possible and contemplated. It should be understood that the system 100 illustrated in FIG. 1 is representative of an example system and that a variety of different system environments and configurations are contemplated and are within the scope of the present disclosure. For example, various acts and/or functionality may be moved from a server 120 to a client device 108, or vice versa, data may be consolidated into a single data store or further segmented into additional data stores, and some implementations may include additional or fewer computing devices, services, and/or networks, and may implement various functionality client or server-side. Furthermore, various entities of the system may be integrated into a single computing device or system or divided into additional computing devices or systems, etc.

FIG. 2 is a block diagram of an example computing device 200 in the system 100.

The computing device 200 may include a processor 204, a memory 206, a display device 216, a communication unit 202, an input/output device(s) 214, and a data storage 208, according to some examples. The components of the computing device 200 are communicatively coupled by a bus 220. In some implementations, the computing device 200 may be representative of the client device 108, the server 120, the observability platform 130, or a combination of the client device 108, the server 120, and the observability platform 130. In such implementations where the computing device 200 is the client device 108, the server 120 or the observability platform 130, it should be understood that the client device 108, the server 120, and the observability platform 130 may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. For example, while not shown, the computing device 200 may include sensors, capture devices, various operating systems, additional processors, and other physical configurations.

As depicted in FIG. 2, the computing device 200 may include a user application 110, a web service 124, a query building engine 104, a variance analysis engine 122, a data disparity engine 126, a database schema module 132, a variance analysis response module 134, a query modification module 136, or a user feedback module 138 depending on the configuration. For instance, a client device 108 may include the user application 110; a server 120 may include the variance analysis engine 122 and web service 124; and the observability platform 130 may include one or more of the query building engine 104, the data disparity engine 126, the database schema module 132, the variance analysis response module 134, the query modification module 136, and the user feedback module 138; although other configurations are also possible and contemplated.

The user application 110 includes computer logic executable by the processor 204 on a client device 108 to provide for user interaction, receive user input, present information to the user via a display, and send data to and receive data from the other entities of the system 100 via the network 102. In some implementations, the user application 110 may generate and present user interfaces based at least in part on information received from the server 120 via the network(s) 102. The user application 110 may perform other operations described herein.

The query building engine 104 may include computer logic executable by the processor 204 to perform operations discussed elsewhere herein. The query building engine 104 may be coupled to the data storage 208 to store, retrieve, and/or manipulate data stored therein and may be coupled to the web service 124, the user application 110, and/or other components of the system 100 to exchange information therewith.

The variance analysis engine 122 may include computer logic executable by the processor 204 to perform operations discussed elsewhere herein. The variance analysis engine 122 may be coupled to the data storage 208 to store, retrieve, and/or manipulate data stored therein and may be coupled to the query building engine 104, the web service 124, and/or other components of the system 100 to exchange information therewith.

The data disparity engine 126 may include computer logic executable by the processor 204 to perform operations discussed elsewhere herein. The data disparity engine 126 may be coupled to the data storage 208 to store, retrieve, and/or manipulate data stored therein and may be coupled to the query building engine 104, the web service 124, and/or other components of the system 100 to exchange information therewith.

The database schema module 132 may include computer logic executable by the processor 204 to perform operations discussed elsewhere herein. The database schema module 132 may be coupled to the data storage 208 to store, retrieve, and/or manipulate data stored therein and may be coupled to the query building engine 104, the web service 124, and/or other components of the system 100 to exchange information therewith.

The variance analysis response module 134 may include computer logic executable by the processor 204 to perform operations discussed elsewhere herein. The variance analysis response module 134 may be coupled to the data storage 208 to store, retrieve, and/or manipulate data stored therein and may be coupled to the query building engine 104, the web service 124, and/or other components of the system 100 to exchange information therewith.

The query modification module 136 may include computer logic executable by the processor 204 to perform operations discussed elsewhere herein. The query modification module 136 may be coupled to the data storage 208 to store, retrieve, and/or manipulate data stored therein and may be coupled to the query building engine 104, the web service 124, and/or other components of the system 100 to exchange information therewith.

The user feedback module 138 may include computer logic executable by the processor 204 to perform operations discussed elsewhere herein. The user feedback module 138 may be coupled to the data storage 208 to store, retrieve, and/or manipulate data stored therein and may be coupled to the query building engine 104, the web service 124, and/or other components of the system 100 to exchange information therewith.

The web service 124 may include computer logic executable by the processor 204 to process content requests and provide access to various services and information resources. The web service 124 may include one or more of a software as a service, infrastructure as a service, platform as a service, function as a service, or other suitable service type. The web service 124 may receive content requests (e.g., product search requests, HTTP requests) from the client device 108, cooperate with the query building engine 104 to determine content, retrieve and incorporate data from the data storage 508, format the content, and provide the content to the client device 108.

In some instances, the web service 124 may format content using a web language and provide the content to a corresponding user application 110 for processing and/or rendering to the user for display. The web service 124 may be coupled to the data storage 208 to store, retrieve, and/or manipulate data stored therein and may be coupled to the query building engine 104 to facilitate its operations, for example.

The processor 204 may execute software instructions by performing various input/output, logical, and/or mathematical operations. The processor 204 may have various computing architectures to process data signals including, for example, a complex instruction set computer (CISC) architecture, a reduced instruction set computer (RISC) architecture, and/or an architecture implementing a combination of instruction sets. The processor 204 may be physical and/or virtual, and may include a single processing unit or a plurality of processing units and/or cores. In some implementations, the processor 204 may be capable of generating and providing electronic display signals to a display device 216, supporting the display of images, capturing and transmitting images, and performing complex tasks including various types of feature extraction and sampling. In some implementations, the processor 204 may be coupled to the memory 206 via the bus 220 to access data and instructions therefrom and store data therein. The bus 220 may couple the processor 204 to the other components of the computing device 200 including, for example, the memory 206, the communication unit 202, the display device 216, the input/output device(s) 214, and the data storage 208.

The memory 206 may store and provide access to data for the other components of the computing device 200. The memory 206 may be included in a single computing device or distributed among a plurality of computing devices as discussed elsewhere herein. In some implementations, the memory 206 may store instructions and/or data that may be executed by the processor 204. For example, the memory 206 may store one or more of the user application 110, query building engine 104, web service 124, variance analysis engine 122, data disparity engine 126, database schema module 132, variance analysis response module 134, query modification module 136, user feedback module 138 and their respective components, depending on the configuration. The instructions and/or data may include code for performing the techniques described herein. The memory 206 is also capable of storing other instructions and data, including, for example, an operating system, hardware drivers, other software applications, databases, etc. The memory 206 may be coupled to the bus 220 for communication with the processor 204 and the other components of the computing device 200.

The memory 206 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 204. In some implementations, the memory 206 may include one or more of volatile memory and non-volatile memory. It should be understood that the memory 206 may be a single device or may include multiple types of devices and configurations.

The bus 220 may represent one or more buses including an industry standard architecture (ISA) bus, a peripheral component interconnect (PCI) bus, a universal serial bus (USB), or some other bus providing similar functionality. The bus 220 may include a communication bus for transferring data between components of the computing device 200 or between computing device 200 and other components of the system 100 via the network 102 or portions thereof, a processor mesh, a combination thereof, etc. In some implementations, the components (e.g., 110, 124, 104, 122, 126, 132, 134, 136, 138) and various other software operating on the computing device 200 (e.g., an operating system, device drivers, etc.) may cooperate and communicate via a software communication mechanism implemented in association with the bus 220. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication may be configured to be secure (e.g., SSH, HTTPS, etc.)

The communication unit 202 is hardware for receiving and transmitting data by linking the processor 204 to the network 102 and other processing systems via signal line 104. The communication unit 202 may receive data such as requests from the client device 108 and transmit the requests to the web service 124 and query building engine 104, for example. The communication unit 202 also transmits information including media to the client device 108 for display, for example, in response to the request. The communication unit 202 is coupled to the bus 220. In some implementations, the communication unit 202 may include a port for direct physical connection to the client device 108 or to another communication channel. For example, the communication unit 202 may include an RJ45 port or similar port for wired communication with the client device 108. In other implementations, the communication unit 202 may include a wireless transceiver (not shown) for exchanging data with the client device 108 or any other communication channel using one or more wireless communication methods, such as IEEE 802.11, IEEE 802.16, Bluetooth® or another suitable wireless communication method. In yet other implementations, the communication unit 202 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still other implementations, the communication unit 202 may include a wired port and a wireless transceiver. The communication unit 202 also provides other conventional connections to the network 102 for distribution of files and/or media objects using standard network protocols such as TCP/IP, HTTP, HTTPS, and SMTP as will be understood to those skilled in the art.

The display device 216 may be any conventional display device, monitor or screen, including but not limited to, a liquid crystal display (LCD), light emitting diode (LED), organic light-emitting diode (OLED) display or any other similarly equipped display device, screen or monitor. The display device 216 represents any device equipped to display user interfaces, electronic images, and data as described herein. In some implementations, the display device 216 may output display in binary (only two different values for pixels), monochrome (multiple shades of one color), or multiple colors and shades. The display device 216 is coupled to the bus 220 for communication with the processor 204 and the other components of the computing device 200. In some implementations, the display device 216 may be a touch-screen display device capable of receiving input from one or more fingers of a user. For example, the display device 216 may be a capacitive touch-screen display device capable of detecting and interpreting multiple points of contact with the display surface. In some implementations, the computing device 200 (e.g., client device 108) may include a graphics adapter (not shown) for rendering and outputting the images and data for presentation on display device 216. The graphics adapter (not shown) may be a separate processing device including a separate processor and memory (not shown) or may be integrated with the processor 204 and memory 206.

The input/output (I/O) device(s) 214 may include any standard device for inputting or outputting information and may be coupled to the computing device 200 either directly or through intervening I/O controllers. In some implementations, the I/O device 214 may include one or more peripheral devices. Non-limiting example I/O devices 214 include a touch screen or any other similarly equipped display device equipped to display user interfaces, electronic images, and data as described herein, a touchpad, a keyboard, a pointing device, a printer, a haptic device, a scanner, an image/video capture device (e.g., camera), a stylus, an audio reproduction device (e.g., speaker), a microphone array, a barcode reader, an eye gaze tracker, a sip-and-puff device, and any other I/O components for facilitating communication and/or interaction with users. In some implementations, the functionality of the I/O device 214 and the display device 216 may be integrated, and a user of the computing device 200 (e.g., client device 108) may interact with the computing device 200 by contacting a surface of the display device 316 using one or more fingers. For example, the user may interact with an emulated (i.e., virtual or soft) keyboard displayed on the touch-screen display device 216 by using fingers to contact the display in the keyboard regions.

The data storage 208 is a non-transitory memory that stores data for providing the functionality described herein. In some implementations, the data storage 208 may be coupled to the components of the computing device 200 via the bus 220 to receive and provide access to data. In some implementations, the data storage 208 may store data received from other elements of the system 100 including, for example, entities 120, 130, 108, and/or the data disparity engine 126, and may provide data access to these entities.

The data storage 208 may be included in the computing device 200 or in another computing device and/or storage system distinct from but coupled to or accessible by the computing device 200. The data storage 208 may include one or more non-transitory computer-readable mediums for storing the data. In some implementations, the data storage 208 may be incorporated with the memory 206 or may be distinct therefrom. The data storage 208 may be a dynamic random-access memory (DRAM) device, a static random-access memory (SRAM) device, flash memory, or some other memory devices. In some implementations, the data storage 208 may include a database management system (DBMS) operable on the computing device 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations. In other implementations, the data storage 208 also may include a non-volatile memory or similar permanent storage device and media including a hard disk drive, a CD-ROM device, a DVD-ROM device, a DVD-RAM device, a DVD-RW device, a flash memory device, or some other mass storage device for storing information on a more permanent basis.

The data stored by the data storage 208 may organized and queried using various criteria including any type of data stored by them, such as described herein. The data storage 208 may include data tables, databases, or other organized collections of data. Examples of the types of data stored by the data storage 208 may include, but are not limited to the data described with respect to the figures, for example.

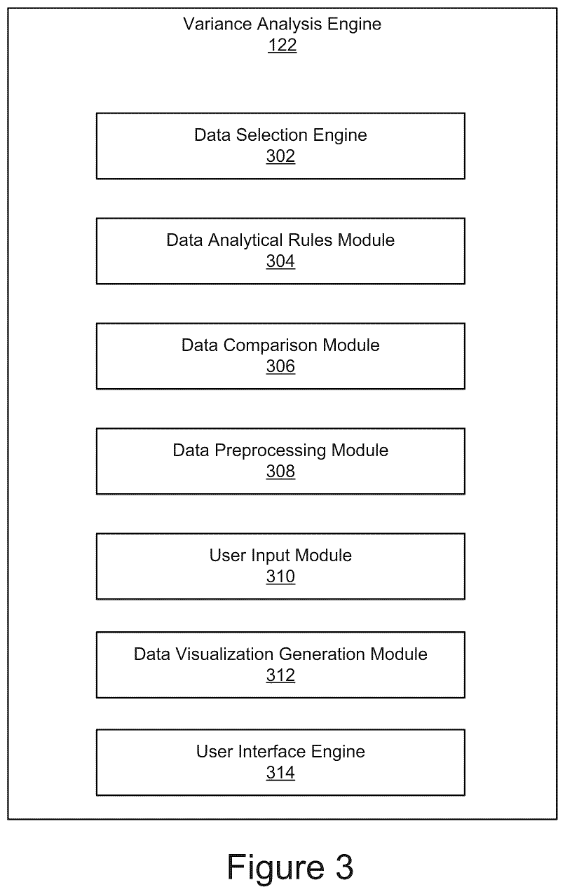

FIG. 3 is a block diagram illustrating a variance analysis engine 122 of the observability platform 130 in accordance with some implementations. The variance analysis engine 122 may include a data selection engine 302 for receiving user input to select data to generate the variance analysis responses, a data analytical rules module 304 for generating, retrieving and/or managing the rules that specify how data will be analyzed in the observability platform 130 to perform variance analysis, a data comparison module 306 for generating, retrieving and/or managing comparison data, a data preprocessing module 308 for generating, retrieving and/or managing the preprocessing of data as input for the variance analysis engine 122, a user input module 310 for managing the user input entered into the user interface by a user 106, a data visualization generation module 312 for generating, retrieving and/or managing data visualizations related to the output of the variance analysis engine 122 and a user interface engine 314 for generating user interface elements in the variance analysis interface as presented on client devices 108. As described above, the database 128 may be used to store data used by the variance analysis engine 122 and each of its components (302, 304, 306, 308, 310, 312, 314).

The data selection engine 302 may include software and/or logic to provide the functionality for receiving user input to select data to generate the variance analysis responses. For example, a user may select a data set based on a user interface interaction, such as highlighting a series of plotted data points that are outliers from a baseline set of data points. In another example, the user may select a user interface element, such as a button, to generate a variance analysis based on the row of tabular data. As another example, the user may select a line plotted on a graph in a user interface and select an option to perform a variance analysis, such as through a drop down menu or other user interface dialog. Any number of user interface interactions may be performed by a user of the observability platform 130 to provide user input to select a dataset for variance analysis.

A data analytical rules module 304 may include software and/or logic to provide the functionality for generating, retrieving and/or managing the rules that specify how data will be analyzed in the observability platform 130 to perform variance analysis. For example, a predetermined set of rules may be installed by administrators of the observability platform 130 on how to conduct the variance analysis. Other rules may be programmed and/or inputted by administrators of the observability platform 130 to generate the variance analysis, in an implementation. In other implementations, rules may be retrieved from a database 128 or may be supplied by a heuristic rules engine.

A data comparison module 306 may include software and/or logic to provide the functionality for generating, retrieving and/or managing comparison data. For example, the data comparison module 306 may be configured to generate comparison data for each dimension of data in the observability platform 130. In other implementations, a number of dimensions may be selected for comparison. The comparison data may be stored in database 128 or another data store, in an implementation.

A data preprocessing module 308 may include software and/or logic to provide the functionality for generating, retrieving and/or managing the preprocessing of data as input for the variance analysis engine 122. Administrators of the observability platform 130 may configure and/or generate queries (and/or pre-queries) that optimize the storage into and retrieval of data from the observability platform 130, such as using database 128. Data that is received into the observability platform 130 is processed to become highly structured data such that arbitrary queries may be executed more quickly and more optimally. This enables the fast and efficient retrieval of data from very large datasets. The data preprocessing module 308 may enable the variance analysis engine 122 to compare large and small datasets because of the arbitrary queries that utilize the highly structured data stored in the database 128. Query results can be quickly analyzed and compared because of the preprocessing that is performed by the data preprocessing module 308. For example, individual data values for a particular dataset may be stored individually in specific files in the database 128 to enable data storage and faster retrieval.

The data preprocessing module 308 may further include any functionality to process the large amounts of data stored in the observability platform 130. Because the data is stored in such a way to take advantage of the arbitrary queries in the observability platform, such as latency rate, HTTP status code, and the like, the performance metric data may be quickly and efficiently analyzed, producing data visualizations that illustrate various predetermined queries in the observability platform 130.

A user input module 310 may include software and/or logic to provide the functionality for managing the user input entered into the user interface by a user 106. For example, other user input, such as text input, selection of links, selection of user interface elements, and selection of data points displayed in user interfaces may be managed through the user input module 310 for use by the administrators of the observability platform 130.

A data visualization generation module 312 may include software and/or logic to provide the functionality for generating, retrieving and/or managing data visualizations related to the output of the variance analysis engine 122. Any number of any type of data visualization may be generated by the data visualization generation module 312. For example, histograms, line graphs, heat maps, bar charts, pie charts, box plots, area charts, line charts, bubble charts, dot distribution maps, dot plots, funnel charts, pivot tables, scatter plots, radar charts, choropleth maps and so forth.

A user interface engine 314 may include software and/or logic to provide the functionality for generating user interface elements in the variance analysis interface as presented on client devices 108. As described above, the database 128 may be used to store data used by the variance analysis engine 122 and each of its components (302, 304, 306, 308, 310, 312, 314).

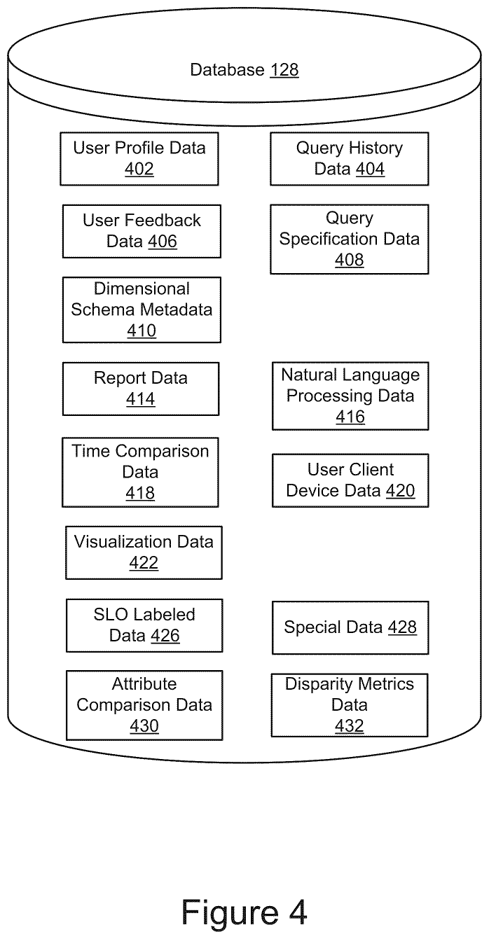

FIG. 4 is a block diagram illustrating a database 128 of the observability platform 130 in accordance with some implementations. As described above, database 128 may be instantiated in a data storage 208 in an example computing device 200 or distributed across multiple computing devices 200 across a distributed data storage 208. Database 128 may include user profile data 402 associated with users 106, query history data 404 that includes the executed queries by users 106, user feedback data 406 that is received based on the executed queries, query specification data 408 that includes the rules of what constitutes a valid query, dimensional schema metadata 410 that includes dimensional information about the database schemas associated with users 106,, report data 414 generated by various functional modules of the observability platform 130, natural language processing data 416 that includes dictionaries and/or other special column names and their meaning, time comparison data 418 that includes data points representing each request in software applications being monitored by users 106, including tracing data, event based data, and time series data, user client device data 420 that includes log data and other data received from client devices 108, visualization data 422 that includes graphical data for creating data visualizations, such as bar graphs, line graphs, and the like, SLO labeled data 426 that includes SLO-labeled data (“Service Level Objective” data) such as an error budget where a checkout function is operational (e.g., returns a 200) for 99% of all events over the past 2 days, and special data 428 that includes data that has been marked as special by one or more algorithms and/or processes. In an implementation, BubbleUp results are not stored in a database, but rather get re-generated every time the user requests them. In other implementations, BubbleUp results may be stored in a data store or cache for performance enhancement purposes.

Other types of data may be stored, such as permalink data that enables variance analysis results to be shared between users or saved for later reference, “BUBBLE UP” data being included in historical query data, and programmatic data that enables variance analysis results to be displayed in other systems, such as SLACK. Additionally, the term “BubbleUp” may be made searchable by various data types, such as “FIELDS” and “ORDER BY” in the observability platform 130. For example, in a search bar, individual results may be made searchable by dimension. Thus, a search phrase such as “BubbleUp by latency” may enable a variance analysis to be performed on the data being presented in the application, in an example implementation. Visualization data may also be stored to differentiate variance analysis response data, such as different color schemes, donut charts for low cardinality, text lists for fields such as “TRACEID” and line charts for continuous values. Furthermore, different user experience designs may be implemented to enable users to access the “BUBBLEUP” function through various types of user interfaces, including a schema sidebar distribution, “BubbleUp on Line Charts,” “1D BubbleUp,” “Get Insights” link and/or icon, “BubbleUp” on a New Query, “BubbleUp” on the Schema, “Root Span BubbleUp,” and so forth. Different types of data may be stored in database 128 to support these different types of user experience designs.

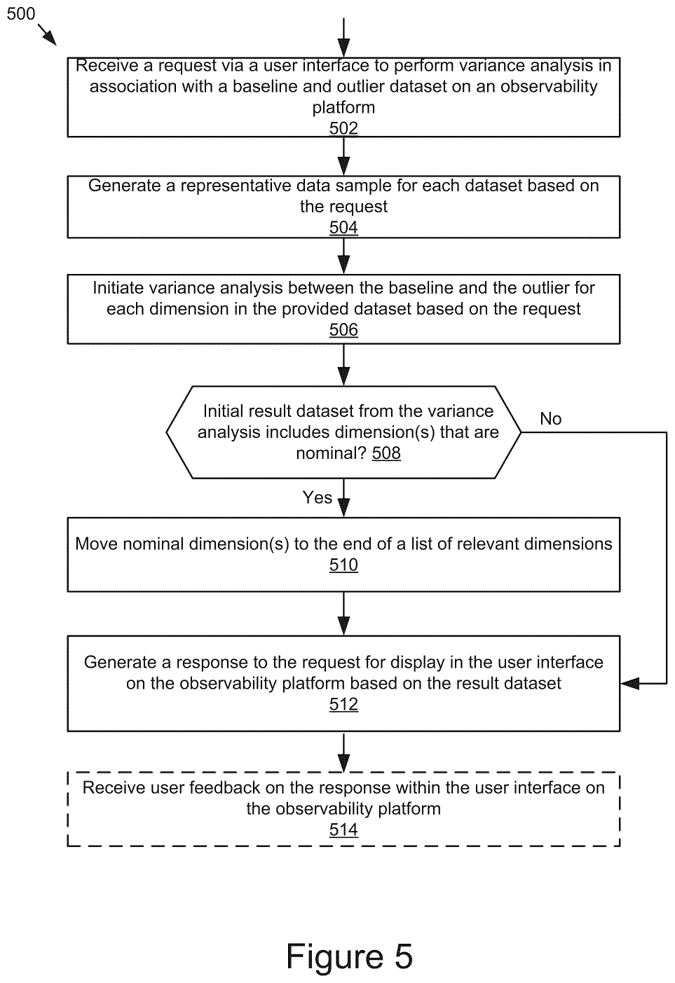

FIG. 5 is an example flowchart diagram illustrating a method 500 of generating a variance analysis associated with a user-selected dataset in accordance with some implementations.

At 502, a request to perform variance analysis in association with a baseline and outlier dataset on an observability platform is received.

At 504, a representative data sample for each dataset is generated based on the

request.

At 506, variance analysis is initiated between the baseline and outlier for each

dimension in the provided datasets based on the request.

At 508, nominal dimensions are identified in the variance analysis. The identified nominal dimensions are then moved to the end of the list of relevant dimensions. A dimension is nominal if the set of unique values for the dimension has a similar size as the set of all values for the dimension (e.g., almost every value in the dimension is unique). A threshold level that defines what qualifies as a nominal dimension may be specified by administrators of the observability platform 130, in an implementation. As another example, the variance analysis engine 122 may determine a likelihood that a dimension is nominal in the observability platform 130 based on one or more probability models using past historically executed queries. As a further example, the variance analysis engine 122 may determine a score that validates a dimension as nominal. Any number of methods and techniques may be used to identify nominal dimensions at step 508.

At 512 a response to the request for display in the user interface on the observability platform based on the result dataset and the nominal data label is generated. At 514, optionally, user feedback is received on the response within the user interface on the observability platform. The method 500 then ends.

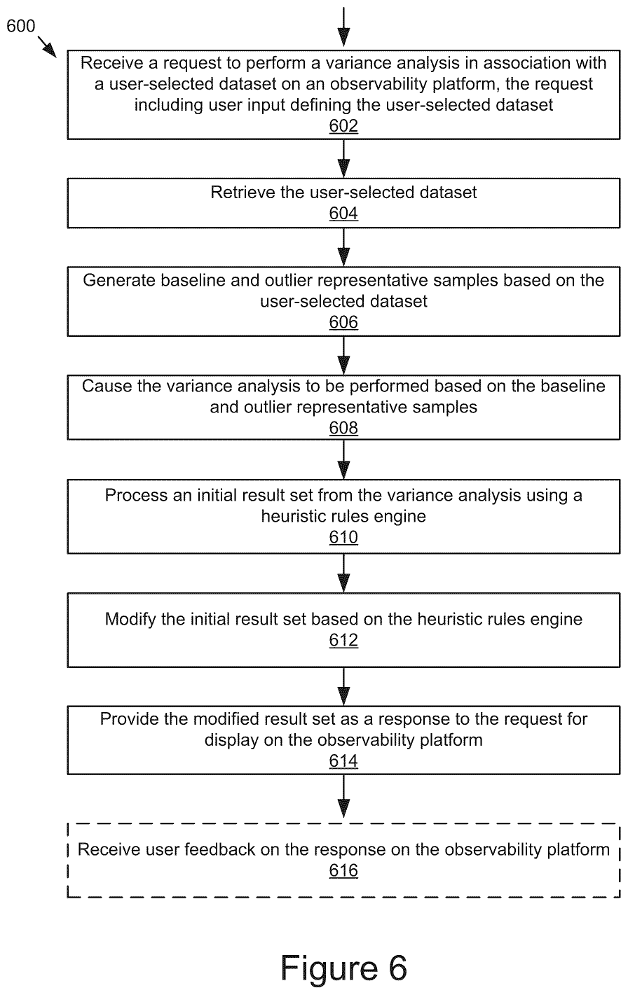

FIG. 6 is an example flowchart diagram illustrating a method 600 of generating a variance analysis associated with a user-selected dataset using a heuristic rules engine in accordance with some implementations.

At 602, a request is received to perform a variance analysis in association with a user-selected dataset on an observability platform 130, the request including user input defining the user-selected dataset.

At 604, the user-selected dataset is retrieved.

At 606, baseline and outlier representative samples are generated based on the user-selected dataset.

At 608, the variance analysis is caused to be performed based on the baseline and outlier representative samples.

At 610, an initial result set is processed from the variance analysis using a heuristic rules engine.

At 612, the initial result set is modified based on the heuristic rules engine.

At 614, the modified result set is provided as a response to the request for display on the observability platform.

At 616, optionally, user feedback is received on the response on the observability platform.

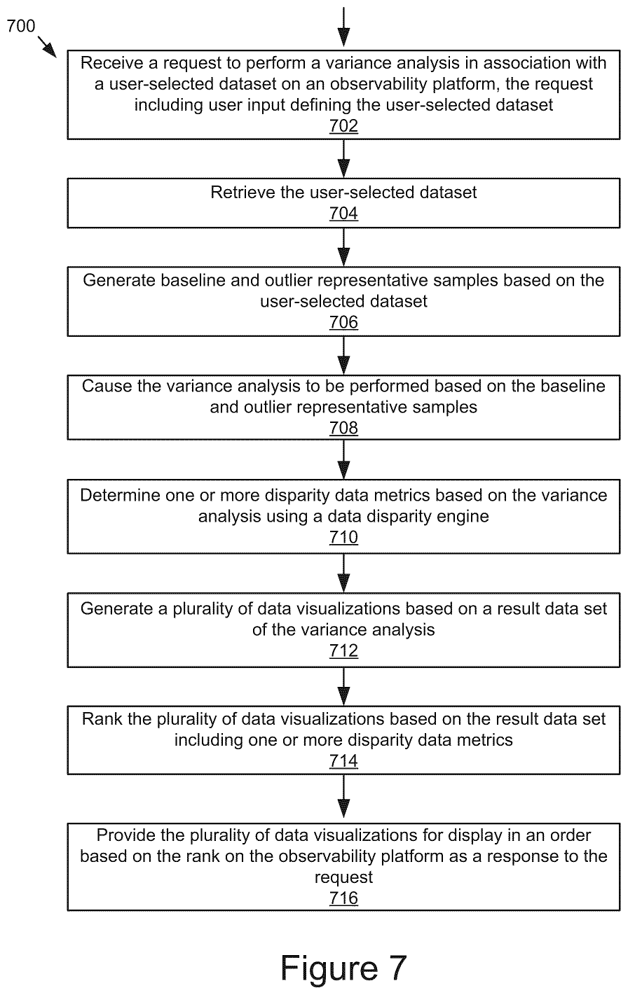

FIG. 7 is an example flowchart diagram illustrating an example method of generating a set of data visualizations based on a variance analysis associated with a user-selected dataset in accordance with an implementation.

At 702, a request is received to perform a variance analysis in association with a user-selected dataset on an observability platform 130, the request including user input defining the user-selected dataset.

At 704, the user-selected dataset is retrieved.

At 706, baseline and outlier representative samples are generated based on the user-selected dataset.

At 708, the variance analysis is caused to be performed based on the baseline and outlier representative samples.

At 710, one or more disparity data metrics are determined based on the variance analysis using a data disparity engine.

At 712, a plurality of data visualizations is generated based on a result data set of the variance analysis.

At 714, the plurality of data visualizations are ranked based on the one or more disparity data metrics.

At 716, the plurality of data visualizations are provided for display in an order based on the rank on the observability platform as a response to the request.

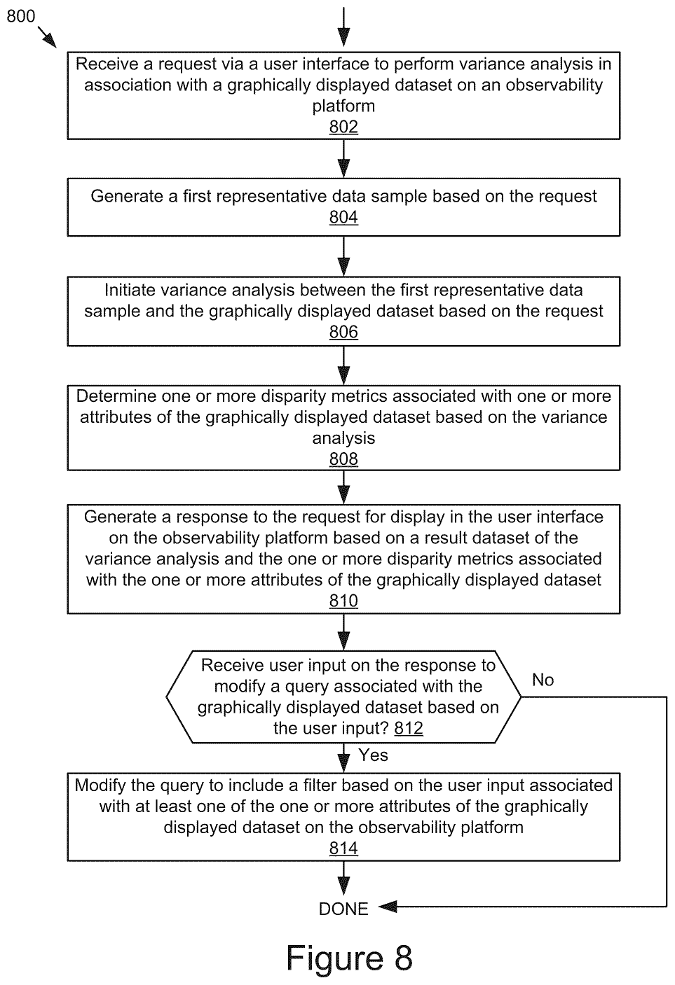

FIG. 8 is an example flowchart diagram illustrating a method of modifying a query based on one or more disparity metrics associated with one or more attributes based on a variance analysis associated with a user-selected dataset in accordance with some implementations.

At 802, a request is received via a user interface to perform a variance analysis in association with a graphically displayed dataset on an observability platform 130.

At 804, a first representative data sample is generated based on the request.

At 806, variance analysis is initiated between the first representative data sample and the graphically displayed dataset based on the request.

At 808, one or more disparity metrics are determined associated with one or more attributes of the graphically displayed dataset based on the variance analysis.

At 810, a response to the request is generated for display in the user interface on the observability platform based on a result dataset of the variance analysis and the one or more disparity metrics associated with the one or more attributes of the graphically displayed dataset.

At 812, a decision point evaluates whether user input has been received on the response to modify a query associated with the graphically displayed dataset based on the user input.

If user input on the response to modify the query is received, then, at 814, the query is modified to include a filter based on the user input associated with at least one of the one or more attributes of the graphically displayed dataset on the observability platform. Otherwise, if user input is not received at decision point 812, the method ends.

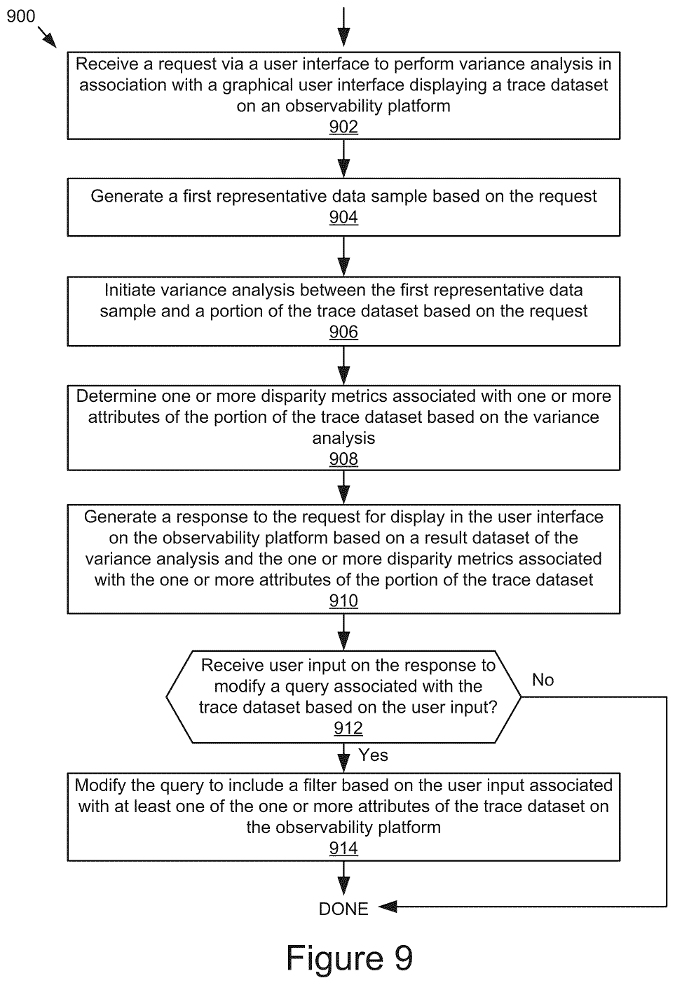

FIG. 9 is an example flowchart diagram illustrating a method of modifying a query to include a filter based on user input associated with one or more disparity metrics associated with one or more attributes of a trace dataset based on a variance analysis associated with a user-selected dataset in accordance with some implementations.

At 902, a request is received via a user interface to perform a variance analysis in association with a graphical user interface displaying a trace dataset on an observability platform 130.

At 904, a first representative data sample is generated based on the request.

At 906, variance analysis is initiated between the first representative data sample and a portion of the trace dataset based on the request.

At 908, one or more disparity metrics are determined associated with one or more attributes of the portion of the trace dataset based on the variance analysis.

At 910, a response to the request is generated for display in the user interface on the observability platform based on a result dataset of the variance analysis and the one or more disparity metrics associated with the one or more attributes of the portion of the trace dataset.

At 912, a decision point evaluates whether user input has been received on the response to modify a query associated with the trace dataset based on the user input.

If user input on the response to modify the query is received, then, at 914, the query is modified to include a filter based on the user input associated with at least one of the one or more attributes of the trace dataset on the observability platform. Otherwise, if user input is not received at decision point 912, the method ends.

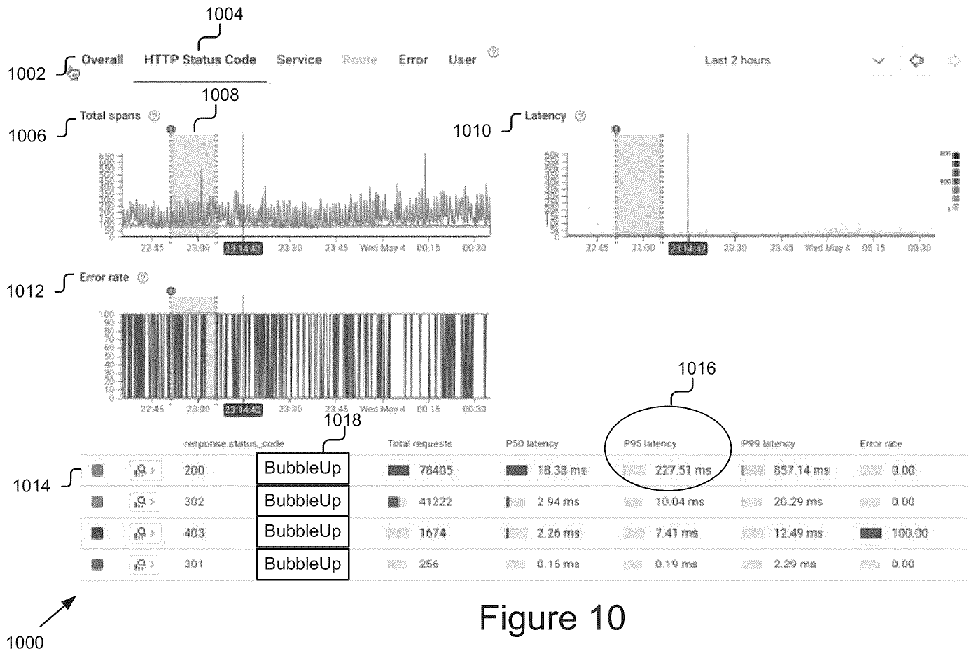

FIG. 10 is an example screenshot illustrating an example set of data visualizations in a user interface 1000 of the observability platform 130 in accordance with an implementation. User interface menu element 1002 includes an example set of tabs for different user interactions with datasets in the observability platform 130, including an “Overall” tab, an “HTTP Status Code” tab, a “Service” tab, a “Route” tab, an “Error” tab, and a “User” tab. Each of the tabs is presented in the user interface 1000 as selectable links that retrieves different data visualizations and/or pre-determined queries in the observability platform 130 on the database 128, for example.

Selected user interface element 1004 depicts the pre-loaded query associated with “HTTP Status Code,” illustrating a line graph data visualization user interface 1006 showing Total Spans in which data points are plotted as lines across a y-axis of number of Total Spans that increases by 50 upwards to 650, and across an x-axis of time from 22:30 on Tuesday May 3^{rd} to 00:30 in fifteen minute increments. The lines are color-coded for the different HTTP Status Codes, such as purple for Status Code 200, orange for Status Code 302, blue for Status Code 403, and green for Status Code 301 as illustrated in table user interface element 1014. The line graph data visualization interface 1006 is selectable such that a portion 1008 of the line graph can be selected by a user 106. The selected portion 1008 enables the user to specify the timeframe of the dataset that includes outlier data that can be compared using a variance analysis to help the user 106 understand why there was a spike in the number of total spans just after 23:00, for example. Alternatively, in the table user interface element 1014, a variance analysis may be performed through the user 106 selecting a button user interface element 1018, for example. While a “BubbleUp” button user element 1018 is illustrated in FIG. 10, other example user interface elements may be employed, such as a drop down menu, a right click menu, a selection menu element, among others.

A heatmap data visualization user interface 1010 may display data points that are plotted across a y-axis of Latency that increases by 5K upwards to 60K, and across an x-axis of time from 22:30 on Tuesday May 3^{rd} to 00:30 in fifteen minute increments, in the same scale as the line graph data visualization user interface 1006. The data points are plotted as dots that are color-coded for the number of occurrences, such as a color palette from light teal to dark purple, where each color is associated with a particular number, such as from 1 for light teal, 400 for turquoise, and 800 for dark purple. In an implementation, the user selected portion 1008 is similarly selected in the heatmap data visualization user interface 1010. In another implementation, by the user selecting the portion 1008 in the line graph data visualization user interface 1006, the corresponding portion of the heatmap data visualization user interface 1010 is selected. FIG. 10 also illustrates an example error rate data visualization user interface 1012, showing a series of lines that are color coded according to the status code. Similarly, a portion of the error rate data visualization user interface 1012 that corresponds to the same time frame as the user-selected portion 1008 may be highlighted in a different color, such as light purple. In the table user interface element 1014, data may be shown by each status code, such as 227.51 ms for P95 latency (95^{th} Percentile Latency), as indicated by the oval 1016 included here for illustration purposes. In other implementations, various indicators may be used to identify data points that may be irregular, as determined by a variance analysis function, such as a highlighted color, a new column of data within the table user interface element 1014, and other such methods of bringing the user's attention to the data.

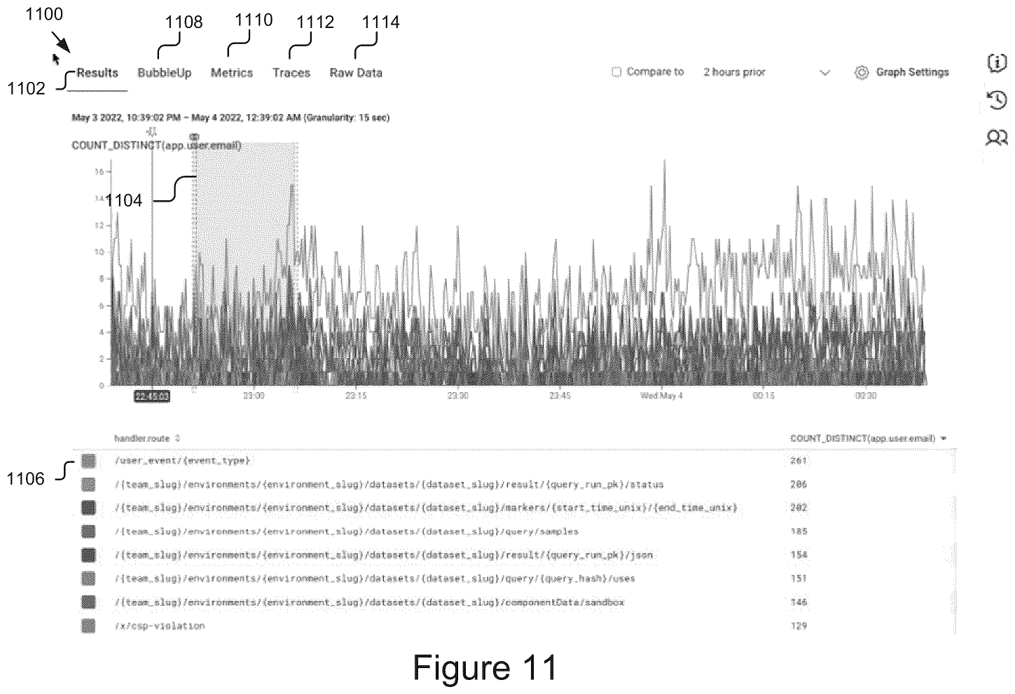

FIG. 11 is an example screenshot illustrating an example data visualization user interface 1100 of the observability platform in accordance with an implementation. User interface navigation menu element 1102 depicts a set of tabs that enable a user 106 to navigate to different data visualizations and/or datasets, including a “Results” tab, a “BubbleUp” tab 1108, a “Metrics” tab 1110, a “Traces” tab 1112, and a “Raw Data” tab 1114. The data visualization user interface 1100 illustrates the “Results” tab, showing a chart with color-coded line graphs showing spikes in the COUNT_DISTINCT (from app.user.email), along a y-axis in 2 increments upwards to 16 and a timeline across the x-axis from 22:30 to 00:30 in fifteen minute increments, similar to the time periods illustrated in FIG. 10. Each line is selectable, enabling a user to generate a variance analysis function on a particular line, for example. The lines may be color coded according to different handler_routes, for example, as illustrated in table 1106. A portion 1104 of the data visualization user interface 1100 may be selected by a user 106 to generate a variance analysis function, in an implementation.

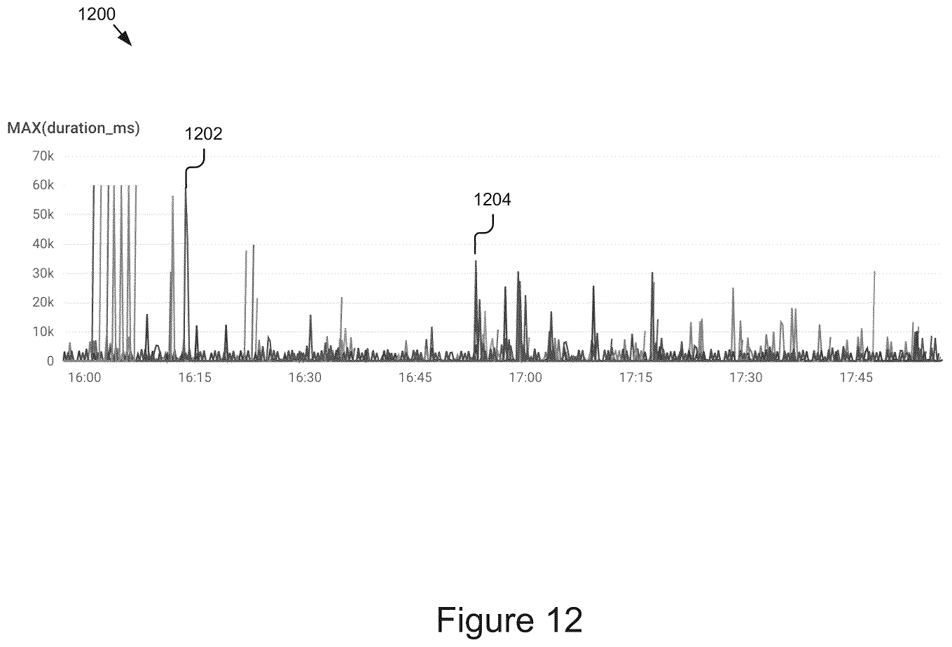

FIG. 12 is an example screenshot illustrating an example line graph data visualization user interface 1200 of the observability platform in accordance with an implementation. A user 106 may select a particular line of the line graph data visualization user interface 1200, such as a peak of a purple line 1202 or a peak of a green line 1204. From the user selection, a drop-down interface may appear to generate a variance analysis function, for example. In other implementations, a series of user interface element interactions, such as a “CTRL” button pressed on a keyboard in combination with a mouse click on the line graph data visualization user interface 1200, such as on the purple line 1202, may be a shortcut to execute a variance analysis function. Any number of user interactions may be employed.

In other implementations, a variance analysis function may be implemented in various contexts, such as making the results more sharable through permalinks, integrations with other systems (e.g., SLACK), having results in a Query History for future reference, enabling search engines to perform a variance analysis function (“BubbleUp”) on fields and order fields and presenting long strings in a more legible way for the user. Other visual presentations may be used for results, such as donut charts for low cardinality, text lists for fields like TraceID, line charts for continuous values, using different color schemes, enabling the variance analysis function to be executed from a multitude of starting points, such as a separate tab, a link to a current result view, from any heatmap visualization, in response to a user wishing to compare two data sets, and so forth. In some implementations, constraints may be placed on what is being shown in the result set of a variance analysis function. Additionally, users may be provided with new ways to access the variance analysis function, such as BubbleUp on Schema, Rootspan/parent span BubbleUp, and BubbleUp on a New Query page/suggested queries.

Measures are high cardinality (more than 75 different values) numeric columns. They are bucketed into groups of values (5-10, 10-15, 15-20) and draw them as overlapping histograms. The blue of an overlapping bar is slightly darker than the blue of a single bar. Dimensions are all drawn as non-overlapping, side-by-side bar charts. Dimensions are broken into Low Cardinality Text, High Cardinality Text, Low Cardinality Numbers, and Nominal Data. With less than 75 discrete values, a bar is drawn for the low cardinality text. If the number of bars is under approximately 20, a caption is put on them. Then, the bars are ordered by decreasing baseline value. This highlights the differences between baseline order and selection order. For example, the fact that “we could . . . ” is high shows it is not just high-its high relative to its order, too. High Cardinality Text is another dimension. With more than 75 discrete values, a bar is drawn for the top 75 bars. Alternately selecting from the selection and the baseline, the process of drawing bars is repeated until 75 values are obtained. If there are fewer than 38 values in one set or the other, all of them are shown. As with low cardinality text, the bars are ordered by decreasing baseline value.

For low cardinality numbers, with fewer than 75 discrete numbers, we show them all. We order numerically without trying to make allowances for numeric scale. For nominal data, an algorithm heuristically guesses whether a column is nominal by checking whether it has lots of singular values, and, if it is, doesn't normalize the data.

In some implementations, a column sometimes is defined on few items. “Null” is therefore a value for some of the items. “Null” values are represented by separating them out into a separate icon representing what percentage of values are defined, or the inverse of the null count. For example, request.url may be defined on only 25% of the selection and 10% of the baseline. Another value, trace.trace_id, may be defined on all of the selection and almost all of the baseline.

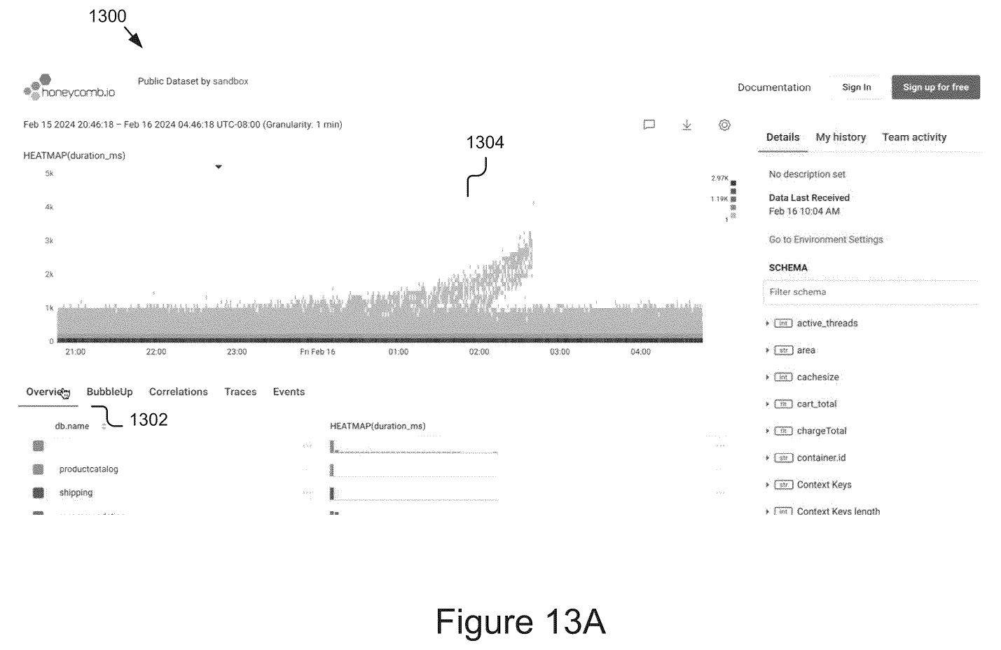

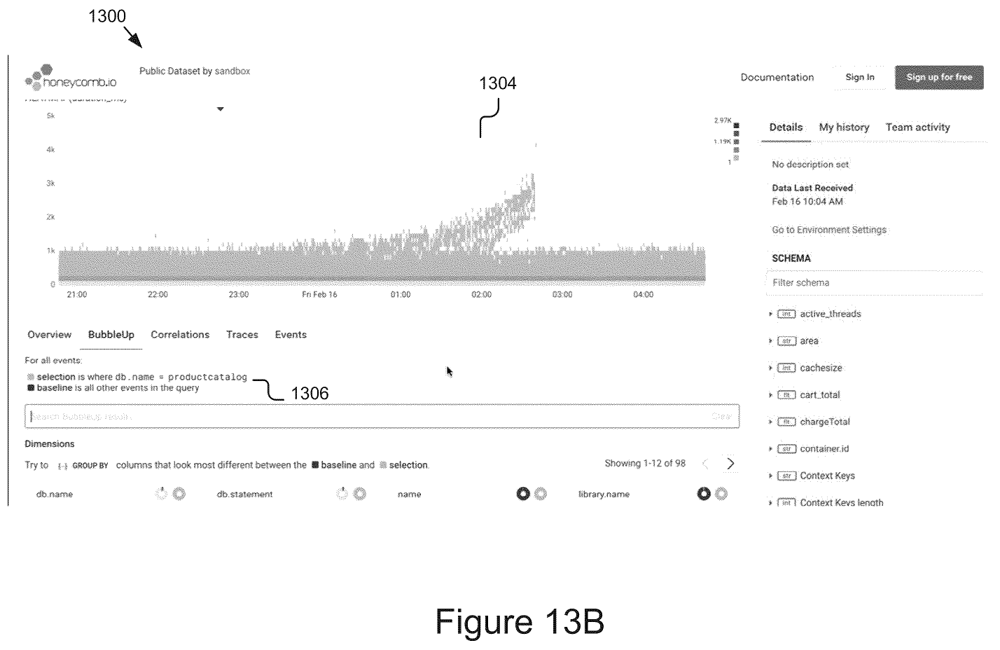

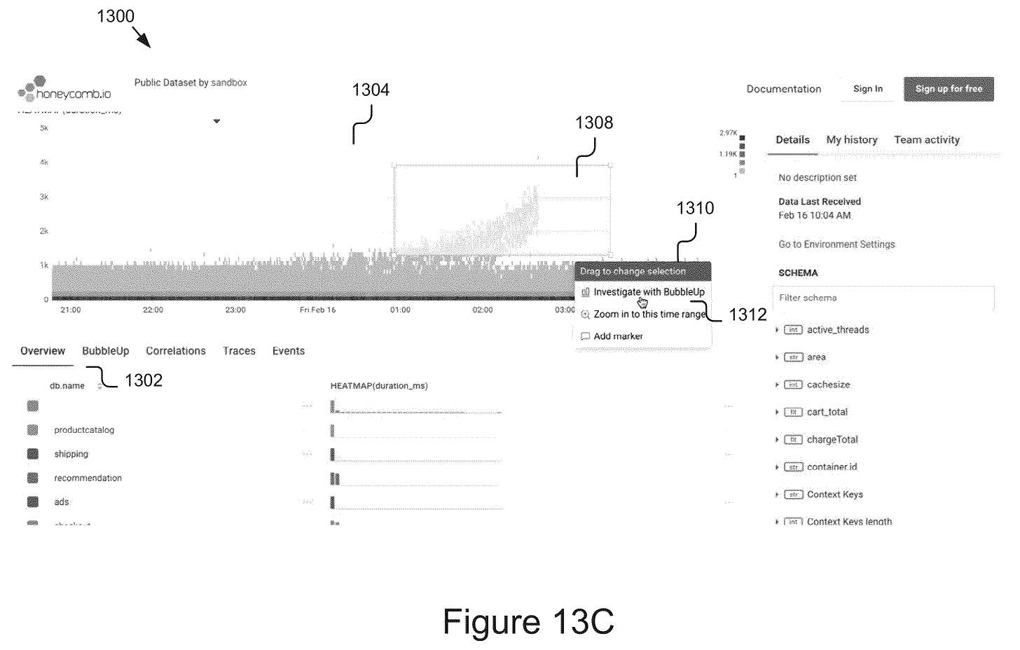

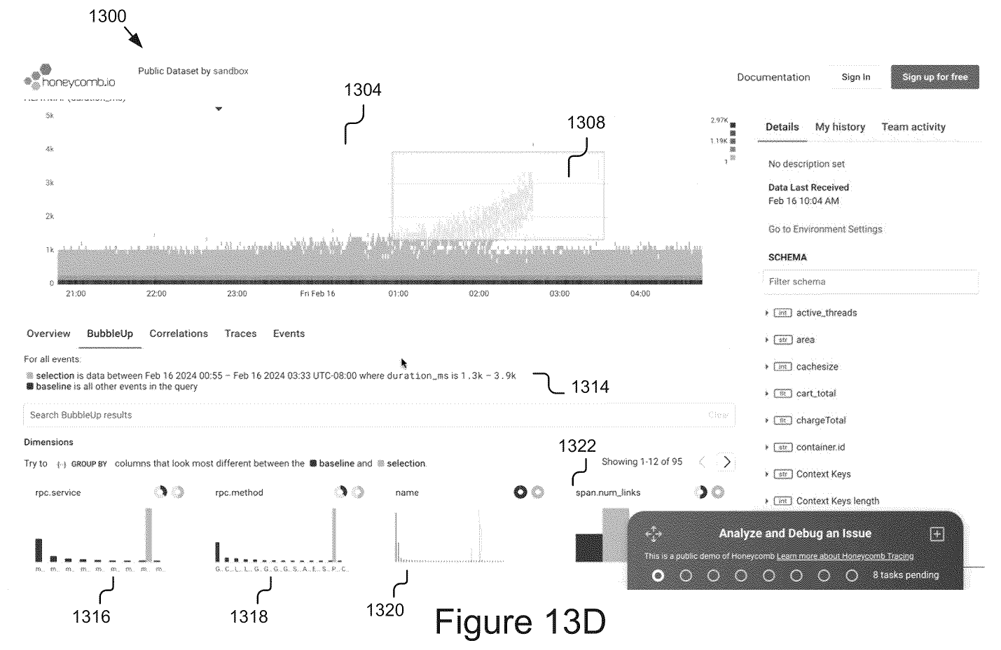

FIGS. 13A-D are example screenshots illustrating an example data visualization user interface 1300 of the observability platform in accordance with an implementation. User interface navigation menu element 1302 depicts a set of tabs that enable a user 106 to navigate to different data visualizations and/or datasets, including an “Overview” tab, a “BubbleUp” tab, a “Correlations” tab, a “Traces” tab, and an “Events” tab. Each tab is selectable. In FIG. 13A, the data visualization user interface 1300 shows a heatmap data plot 1304 that illustrates events in different colors, ranging from light blue-green that represents fewer events to a darker teal that represents 1.19K events to a darker blue that represents 2.9K events, as shown in the legend. The heatmap data plot 1304 visually shows a number of increasing events between 01:00 and 03:00. Additionally, different data sources are listed, including “productcatalog” in orange. A user 106 may select a particular data sources of the data visualization user interface 1300, such as the “productcatalog” row. From the user selection, a variance analysis function may be generated to select the data from the “productcatalog” data source, for example, as shown in FIG. 13B. The selection 1306 is clearly shown in FIG. 13B, stating that “selection is where db.name =productcatalog” as the caption. The data visualization user interface 1300 is also updated to show the corresponding data after the executed variance analysis function, in an embodiment. FIG. 13C illustrates an aforementioned example where a data selection 1308 on the heatmap dataplot 1304 is selected. The user-selected range, illustrated as the data selection 1308 box, may further include a datapoint that may be used to execute the variance analysis function, in an embodiment. A dropdown menu 1310 may be shown or displayed upon the user 106 right-clicking after the selection 1308. A link to “Investigate with BubbleUp” 1312 may be selected, resulting in the variance analysis function to be executed on that user-generated selection 1308, as shown in FIG. 13D. An updated statement 1314 on the selection describes that “selection is data between Feb. 16, 2024 00:55-Feb. 16, 2024 03:33 UTC-08:00 where duration_ms is 1.3k-3.9k” as shown in FIG. 13D. Additionally, histogram comparisons are shown between the selection in yellow and baseline in dark blue across various dimensions. For example, “rpc.service” is shown in graph 1316, “rpc.method” is shown in graph 1318, “name” is shown in graph 1320, and “span.num_links” is shown in graph 1322. In this way, the user 106 is presented with a number of dimensions where there exists a variance between the selection 1308 and the baseline. Any number of user interactions may be employed, in various embodiments.

It should be understood that other processors, operating systems, sensors, displays, and physical configurations are possible.

It should be understood that the methods described herein are provided by way of example, and that variations and combinations of these methods, as well as other methods, are contemplated. For example, in some implementations, at least a portion of one or more of the methods represent various segments of one or more larger methods and may be concatenated or various steps of these methods may be combined to produce other methods which are encompassed by the present disclosure. Additionally, it should be understood that various operations in the methods are iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

Reference in the specification to “one implementation” or “an implementation” means that a particular feature, structure, or characteristic described in connection with the implementation is included in at least one implementation. The appearances of the phrase “in one implementation” in various places in the specification are not necessarily all referring to the same implementation.

In some instances, various implementations may be presented herein in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic disks, read-only memories (ROMs), random access memories (RAMs), EPROMS, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code, such as the computing systems, entities, and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

Network adapters may also be coupled to the system to enable the data processing system to become coupled to other data processing systems, storage devices, remote printers, etc., through intervening private and/or public networks. Wireless (e.g., Wi-FiTM) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

1. A computer-implemented method comprising:
receiving a request to perform a variance analysis in association with a user-selected dataset on an observability platform, the request including user input defining the user-selected dataset including at least one user-selected datapoint identified by the user input;
generating an outlier representative sample based on data representing the user-selected dataset and the at least one user-selected datapoint;
generating a baseline representative sample based on the data representing the user-selected dataset;
causing the variance analysis to be performed based on the at least one user-selected datapoint, the baseline representative sample, and the outlier representative sample;
generating a plurality of data visualizations based on a result data set of the variance analysis and a description of the user-selected dataset based on the user input;
ranking the plurality of data visualizations based on the result data set including one or more disparity data metrics; and
providing the plurality of data visualizations and the description of the user-selected dataset for display in an order based on the ranking on the observability platform as a response to the request.

2. The computer-implemented method of claim 1, further comprising:
receiving user feedback on the response to the request on the observability platform, the user feedback identifying a dataset; and
modifying a query associated with the result data set to include a filter based on the user feedback associated with at least one of the one or more disparity data metrics, wherein the filter is based on the dataset identified by the user feedback.

3. The computer-implemented method of claim 1, wherein the baseline representative sample and the outlier representative sample are generated based on randomly selecting a predetermined set of values.

4. The computer-implemented method of claim 1, wherein the variance analysis is performed using an application programming interface call to a web service communicatively coupled to a variance analysis engine.

5. The computer-implemented method of claim 1, wherein the result data set of the variance analysis comprises a plurality of data dimensions with a corresponding plurality of data values that detail the one or more disparity data metrics.

6. The computer-implemented method of claim 5, wherein the variance analysis comprises:
comparing the baseline representative sample to the outlier representative sample across all data dimensions in the user-selected dataset retrieved from the observability platform;
determining the plurality of data dimensions with the corresponding plurality of data values based on one or more disparity thresholds; and
generating the one or more disparity data metrics based on the plurality of data values between the baseline representative sample and the outlier representative sample.

7. The computer-implemented method of claim 1, wherein the variance analysis uses a heuristic rules engine to determine the result data set including the one or more disparity data metrics.

8. A system comprising one or more processors and memory operably coupled with the one or more processors, wherein the memory stores instructions that, in response to execution of the instructions by one or more processors, cause the one or more processors to perform operations including:
receiving a request to perform a variance analysis in association with a user-selected dataset on an observability platform, the request including user input defining the user-selected dataset including at least one user-selected datapoint identified by the user input;
generating an outlier representative sample based on data representing the user-selected dataset and the at least one user-selected datapoint;
generating a baseline representative sample based on the data representing the user-selected dataset;
causing the variance analysis to be performed based on the at least one user-selected datapoint, the baseline representative sample, and the outlier representative sample;
generating a plurality of data visualizations based on a result data set of the variance analysis and a description of the user-selected dataset based on the user input;
ranking the plurality of data visualizations based on the result data set including one or more disparity data metrics; and
providing the plurality of data visualizations and the description of the user-selected dataset for display in an order based on the ranking on the observability platform as a response to the request.

9. The system of claim 8, wherein the operations further comprise:
receiving user feedback on the response to the request on the observability platform, the user feedback identifying a dataset; and
modifying a query associated with the result data set to include a filter based on the user feedback associated with at least one of the one or more disparity data metrics, wherein the filter is based on the dataset identified by the user feedback.

10. The system of claim 8, wherein the baseline representative sample is generated based on randomly selecting a predetermined set of values.

11. The system of claim 8, wherein the variance analysis is performed using an application programming interface call to a web service communicatively coupled to a variance analysis engine.

12. The system of claim 8, wherein the result data set of the variance analysis comprises a plurality of data dimensions with a corresponding plurality of data values that detail the one or more disparity data metrics.

13. The system of claim 12, wherein the variance analysis comprises:
comparing the baseline representative sample to the outlier representative sample across all data dimensions in the user-selected dataset retrieved from the observability platform;
determining the plurality of data dimensions with the corresponding plurality of data values based on one or more disparity thresholds; and
generating the one or more disparity data metrics based on the plurality of data values between the baseline representative sample and the outlier representative sample.

14. The system of claim 8, wherein the variance analysis uses a heuristic rules engine to determine the result data set including the one or more disparity data metrics.

15. One or more non-transitory computer-readable storage media storing one or more sequences of instructions which, when executed using one or more processors, cause the one or more processors to:
receive a request to perform a variance analysis in association with a user-selected dataset on an observability platform, the request including user input defining the user-selected dataset including at least one user-selected datapoint identified by the user input;
generate an outlier representative sample based on data representing the user-selected dataset and the at least one user-selected datapoint;
generate a baseline representative sample based on the data representing user-selected dataset;
cause the variance analysis to be performed based on the at least one user-selected datapoint, the baseline representative sample, and the outlier representative sample;
generate a plurality of data visualizations based on a result data set of the variance analysis and a description of the user-selected dataset based on the user input;
rank the plurality of data visualizations based on the result data set including one or more disparity data metrics; and
provide the plurality of data visualizations and the description of the user-selected dataset for display in an order based on the ranking on the observability platform as a response to the request.

16. The one or more non-transitory computer-readable storage media of claim 15, wherein the one or more processors are further caused to:
receive user feedback on the response to the request on the observability platform, the user feedback identifying a dataset; and
modify a query associated with the result data set to include a filter based on the user feedback associated with at least one of the one or more disparity data metrics, wherein the filter is based on the dataset identified by the user feedback.

17. The one or more non-transitory computer-readable storage media of claim 15, wherein the baseline representative sample is generated based on randomly selecting a predetermined set of values.

18. The one or more non-transitory computer-readable storage media of claim 15, wherein the result data set of the variance analysis comprises a plurality of data dimensions with a corresponding plurality of data values that detail the one or more disparity data metrics.

19. The one or more non-transitory computer-readable storage media of claim 18, wherein the variance analysis comprises:
comparing the baseline representative sample to the outlier representative sample across all data dimensions in the user-selected dataset retrieved from the observability platform;
determining the plurality of data dimensions with the corresponding plurality of data values based on one or more disparity thresholds; and
generating the one or more disparity data metrics based on the plurality of data values between the baseline representative sample and the outlier representative sample.

20. The one or more non-transitory computer-readable storage media of claim 15, wherein the variance analysis uses a heuristic rules engine to determine the result data set including the one or more disparity data metrics.
